(19) United States
(12) Patent Application Publication
(10) Pub. No.: US 2006/0287848 A1
(43) Pub. Date: Dec. 21, 2006

(54) Language classification with random feature clustering

(75) Inventors: Mu Li, Beijing (CN); Jianfeng Gao, Beijing (CN); Ming Zhou, Beining (CN)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/157,091

(22) Filed: Jun. 20, 2005

(51) Int. Cl. G06F 17/27

(52) U.S. Cl. 704/9

(57) ABSTRACT

An ensemble of random feature clusters is built from training data using a clustering algorithm where some randomness has been introduced. For each clustered feature space, a classifier, such as a Naïve Bayesian Classifier, is trained, realizing a classifier ensemble. The final classification decision is made by the resulting classifier ensemble.

### BACKGROUND

The discussion below is merely provided for general background information and is not intended to be used as an aid in determining the scope of the claimed subject matter.

A common application today is the entering, editing and manipulation of text. Application programs that perform such text operation include word processors, text editors, and even spreadsheets and presentation programs. For example, a word processor allows a user to enter text to prepare documents such as letters, reports, memos, etc. While the keyboard has historically been the standard input device by which text input is performed into these types of application programs, it is currently being augmented and/or replaced by other types of input devices. For example, touch-sensitive pads can be “written” on with a stylus, such that a handwriting recognition program can be used to input the resulting characters into a program. As another example, voice-recognition programs, which work in conjunction with microphones attached to computers, also are becoming more popular. Especially for non-English language users, and particularly for Asian language users, these non-keyboard type devices are popular for initially inputting text into programs, such that they can then be edited by the same device, or other devices like the keyboard. Speech and handwriting recognition have applications beyond text entry as well.

A primary part of the use of handwriting or speech recognition is the selection of a domain language model that is used to determine what a user writes or speaks should be translated to. For many domains, particularly those directed to a specific domain, statistical language models usually suffer from a data sparseness problem, because large amounts of domain-specific data are usually not available. Statistical models trained on insufficient training data tend to over fit and perform poorly on unseen events. This problem has traditionally been dealt with by various smoothing techniques, e.g. assigning non-zero probabilities to unseen events in language models or Naïve Bayesian Classifiers (“NBC”).

An alternative approach to the sparse data problem is to use feature clusters. In natural language processing (“NLP”) tasks, a cluster is typically defined as a set of similar words. For example, words “red” and “yellow” belong to a cluster “COLOR”, while “Tuesday” and “Wednesday” belong to a “WEEKDAY” class. Clusters can be automatically generated using statistical criteria such as entropy and model reconstruction cost. Although clustering can be an effective technique for model compression and performance improvement, using word clusters can be problematic in some cases. First, cluster based models may be worse than word based models because of the over-generalization of the words. In addition, clustering algorithms, such as k-means and hierarchical clustering, are greedy in nature, hence tend to converge to a local optimum. As a result, the obtained clusters are sub-optimal.

### SUMMARY

This Summary is provided to introduce some concepts in a simplified from that are further described below in the Detailed Description. This Summary is not intended to identify key features or essential features of the claimed subject matter, nor is it intended to be used as an aid in determining the scope of the claimed subject matter.

Generally, a technique herein also referred to as “random feature clustering” is provided to improve the accuracy of a statistical classifier. In this approach, an ensemble of random feature clusters is built from training data using a clustering algorithm where some randomness has been introduced. For each clustered feature space, a classifier, such as a Naïve Bayesian Classifier, is trained, realizing a classifier ensemble. The final classification decision is made by the resulting classifier ensemble.

### BRIEF DESCRIPTION OF THE DRAWINGS

FIG. 1 is a block diagram of one embodiment of an environment in which aspects of the present invention can be used.

FIG. 2 is a flow chart illustrating a method of training a classifier.

FIG. 3 is a block diagram illustrating modules and data for performing the methods of FIG. 2 and FIG. 4.

FIG. 4 is a flow chart illustrating a method of operating classifier.

### DETAILED DESCRIPTION

One aspect herein described relates to a classifier based on random feature clustering. However, prior to discussing this and other aspects in greater detail, one illustrative environment in which the present invention can be used will be discussed.

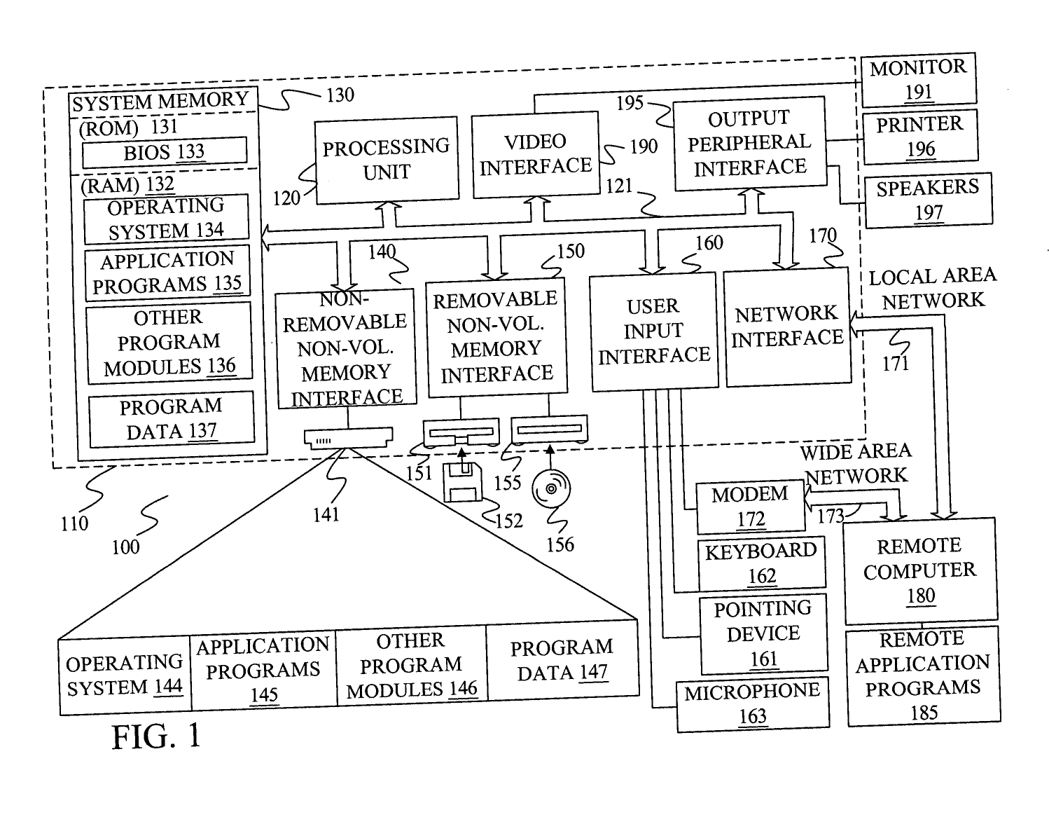

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. Those skilled in the art can implement the description and/or figures herein as computer-executable instructions, which can be embodied on any form of computer readable media discussed below.

The invention may also be practiced in distributed computing environments where tasks are performed by remote processing devices that are linked through a communications network. In a distributed computing environment, program modules may be located in both locale and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a locale bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) locale bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 100. Communication media typically embodies computer readable instructions, data structures, program modules or other data in a modulated data signal such as a carrier WAV or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, FR, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way o example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a locale area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

It should be noted that the present invention can be carried out on a computer system such as that described with respect to FIG. 1. However, the present invention can be carried out on a server, a computer devoted to message handling, or on a distributed system in which different portions of the present invention are carried out on different parts of the distributed computing system.

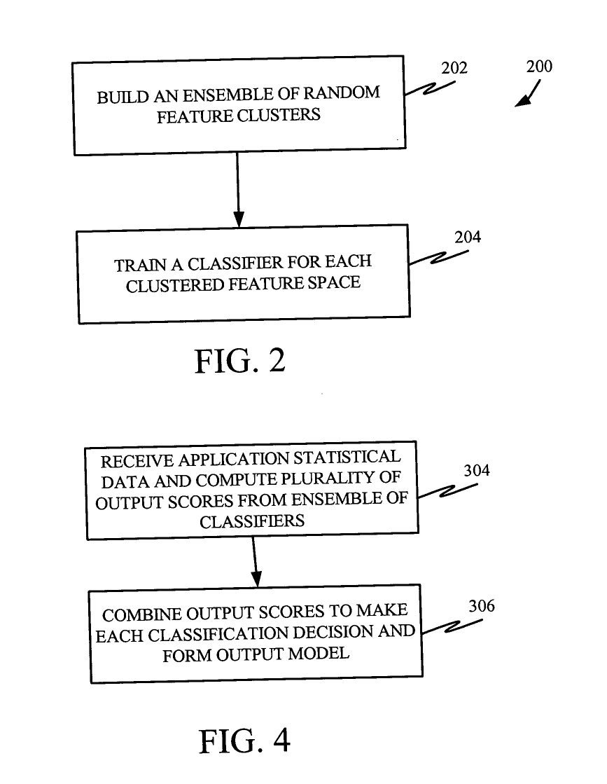

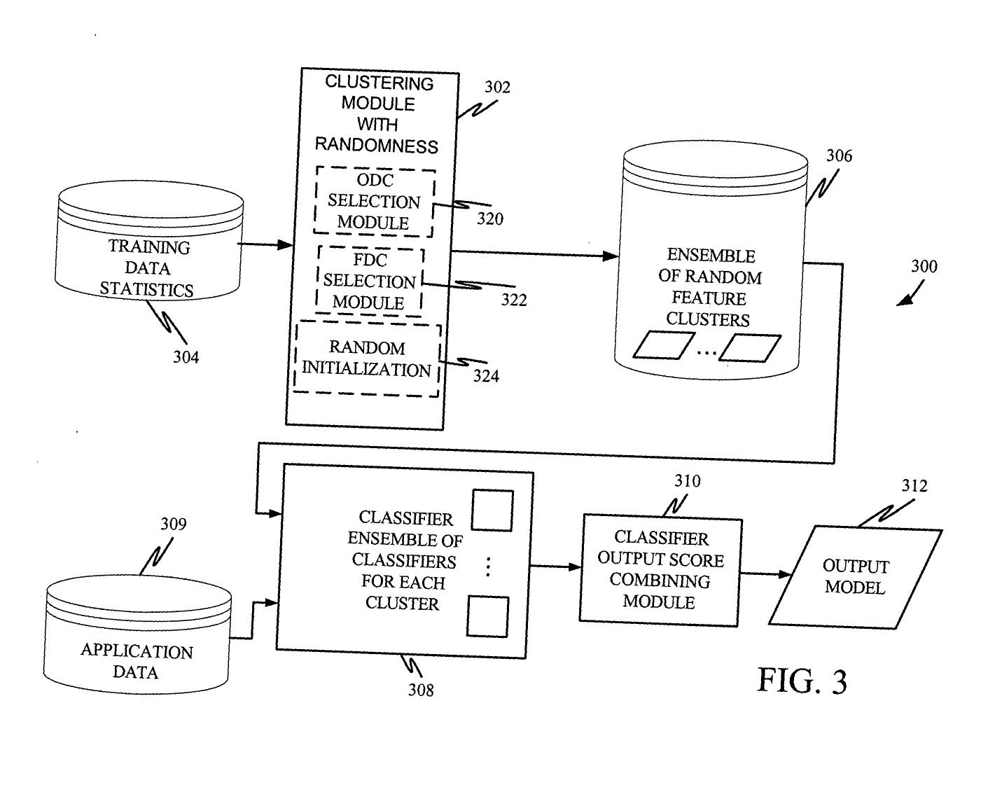

As indicated above, an aspect of the present invention includes a new clustering technique herein also referred to as random feature clustering to improve the accuracy of a statistical classifier. FIG. 2 generally illustrates such a method at 200, while system 300 schematically illustrated in FIG. 3 provides components or modules for performing method 200. The modules and corpus storage devices illustrated in FIG. 3 can be embodied using the environment described above without limitation.

A clustering module 302 having randomness receives training data statistics 304 of a domain and builds an ensemble of random feature clusters 306 as indicated by step 202. A classifier assembly 308 comprising an ensemble of classifiers is built at step 204. Each classifier of the ensemble 308 corresponds to a random feature cluster of the ensemble 306.

In operation as illustrated in FIG. 4, clustering ensemble or assembly 308 receives statistical data from an application domain 309 wherein each of the classifiers of the ensemble 308 provides an output score as indicated at step 402. A classifier output combining module 310 receives each of the output scores and combines them to generate a classification decision at step 404 used in order to form an output model 312.

Referring now to the components in detail, a Naïve Bayesian Classifier (NBC) can be used as the base classifier in the ensemble 308. Other classifiers can be used such as but not limited to Support Vector Machines (SVM), Neural Networks and Decision Tree. An NBC is a simple and effective multi-class linear classifier of text data. Let C={c₁,c₂, . . . ,c₁} be a set of 1 classes, W={w₁,w₂, . . . ,wₘ} be a set of features (e.g. words). Given an example in the form of feature vector e={wₜ₁,wₜ₂, . . . ,wₜₙ}, the probability that e predicts class cᵢ is estimated as:

$$p ( {c}_{i} \vert e ) = \frac{p ( e \vert {c}_{i} ) p ( {c}_{i} )}{p ( e )}$$

By introducing the independence assumption between each feature in e and taking into account that p(e) is a constant over all classes, the final decision rule can be rewritten as

$$\begin{matrix}c ( e ) = arg {max}_{{c}_{i}} p ( {c}_{i} \vert e ) \\ = arg {max}_{{c}_{i}} p ( {c}_{i} ) {\prod }_{t = 1}^{m} {p ( {w}_{t} \vert {c}_{i} )}^{n ( {w}_{t} , {c}_{i} )}\end{matrix}$$

where n(wₜ,cᵢ) is the number of occurrences of feature wₜ in e.

The prior probability p(cᵢ) is usually estimated by maximum likelihood estimation (MLE) method as

$$p ( {c}_{i} ) = \vert {c}_{i} \vert / {\sum }_{{c}_{i} ∈ C} \vert {c}_{j} \vert .$$

The estimation of the conditional probability p(wₜ|cᵢ), however, needs to be smoothed in most task settings. Hard clustering methods, which aim to split a set of objects into multiple non-overlapping subsets represented by a cluster can be used; however such methods should not be considered limiting.

Three suitable but not exclusive clustering algorithms that clustering module 302 can implement to automatically derive word clusters from training data statistics are provided below. Both of the algorithms do not guarantee finding the global optima of their objective functions, and the outputs are sensitive to their initial states.

Minimum Entropy Clustering (MEC). This clustering algorithm is essentially adapted from the work described in “The Use of Clustering Techniques for Language Modeling—Application to Asian Languages”, by Jianfeng Gao, Joshua Goodman, Jiangbo Miao, published in Computational Linguistics and Chinese Language Processing, 6(1):27-60, 2001, which was originally developed for statistical language modeling. This clustering algorithm performs clustering by minimizing the entropy of the given set of events. This algorithm performs probabilistic asymmetric clustering. Let W denote the cluster w belongs to. Based on how the cluster is used, it tries to optimize the training data entropy in terms of predictive clustering

$$\sum p ( {W}_{i} \vert {w}_{i - 1} ) log p ( {W}_{i} \vert {w}_{i - 1} )$$

or conditional clustering

$$\sum p ( {w}_{i} \vert {W}_{i - 1} ) log p ( {w}_{i} \vert {W}_{i - 1} ) .$$

In NBC, since the features for each class are assumed to be independent, the model parameters p(wᵢ|c) can be estimated very similarly to bigram probabilities in language models. To cluster features, predictive clustering is adapted by optimizing the following criterion

$$\sum p ( {W}_{j} \vert {c}_{i} ) log p ( {W}_{j} \vert {c}_{i} )$$

over the training set.

The algorithm uses a top-down, splitting clustering algorithm. In each iteration, a cluster is split into two clusters in a way that the splitting achieves the maximal entropy decrease. After all the splitting is finished, several iterations of global swapping are performed between all clusters until convergence (no swapping occurs). Therefore, the output of the algorithm is a binary-branching, hierarchical clustering tree.

Divisive Clustering (DC). This algorithm was originally proposed in “A Divisive Information-Theoretic Feature Clustering Algorithm for Text Classification”, by Inderjit S. Dhillon, Subramanyam Mallela and Rahul Kumar, published in Journal of Machine Learning Research. 2:1265-1287 (2003), as a special variant of the classical k-means clustering algorithm for text classification. It has also been proved that the algorithm has some nice properties such as minimizing “within-cluster divergence” and simultaneously maximizing “between-cluster divergence”.

Divisive clustering uses Kullback-Leibler (KL) divergence, instead of the Euclidean distance, as the distance metric between two objects. Since clustered objects are represented by feature vectors, the statistics of classes associated with each NBC feature are viewed as features for clustering purposes on which the clustering algorithm operates. To be more specific, a real-valued feature vector is used to represent each NBC feature to be clustered. In the vector, the i-th dimension corresponds to classification class cᵢ and the feature value is set as the conditional probability p(cᵢ|wₜ) when the object to be clustered is NBC feature wₜ. In other words, the feature vector contains real-valued elements. Each feature value is the conditional probability. So the vector indicates a distribution over the class set C. The similarity between 2 feature vectors (or 2 objects) is the KL distance between the two distributions represented by the two vectors. Therefore, the feature vector actually indicates a probabilistic distribution over the set of classification classes C
F(wₜ)={p(c|wₜ)|c ε C}
Then the distance between wₜ₁ and wₜ₂ can be computed in terms of KL divergence as

$$D ( {w}_{t 1} \vert \vert {W}_{t 2} ) = {\sum }_{c} p ( c \vert {w}_{t 1} ) log \frac{p ( c \vert {w}_{t 1} )}{p ( c \vert {w}_{t 2} )}$$

and the mean of a cluster L-(wₜ₁,wₜ₂, . . . ,wₜₙ) is computed as
μ(L)={p(c|L)|c ε C}
where

$$p ( c \vert L ) = {\sum }_{{w}_{t} ∈ L} \frac{p ( {w}_{t} ) p ( c \vert {w}_{t} )}{{\sum }_{{w}_{t} ∈ L} p ( {w}_{t} )}$$

The time complexity of this algorithm is O(mklτ), where m is the vocabulary size, k is the number of clusters, l is the number of classes and τ is the number of iterations.

DC/MEC A slightly modified version of the algorithm can be used to take advantage of the top-down binary hierarchical clustering framework used in the minimum entropy clustering algorithm described above. First, the entire feature set is split into two clusters using the divisive clustering algorithm. Then the resulting two clusters are recursively split as such until desired levels of hierarchy achieved.

This modification speeds up the clustering process by a factor of k/2[log(k)] when k is the desired number of clusters. To obtain k clusters, a clustering tree is built whose depth is given by log(k). Since at each level the time complexity is O(2mlτ), the overall time complexity of the new algorithm is O(2m log(k)lτ) rather than O(mklτ) for the original algorithm. This is a significant improvement when k is large.

It is believed that the desired diversity of clustering results can be achieved by a systematic way of building clusters from training data. Similarities based on different aspects of the clustered object are expected to be modeled by different clustering results through the randomized clustering process. Three methods to inject randomness into the clustering process are provided below.

Object-Distributed Clustering (ODC) represented by module 320. This method is similar to the bagging method described in “Bagging Predictors”, by L. Breiman, published in Machine Learning, 26(2) :123-140, 1996, which builds classifier ensembles. This is also known as training set subsampling for example as described in “The Random Subspace Method for Constructing Decision Forests”, by Tin Kam Ho, published in IEEE Trans. on Pattern Analysis and Machine Intelligence, 20(8) :832-844, 1998. A sampling process runs over the training set for specified number of iterations. In each iteration, a subset of training data is extracted with random replacements. Then a set of clusters is derived from the extracted subset. In the ODC scenario, the clustering algorithm can access all of the features of the clustered objects, but can only have a subset of training data to perform clustering.

Feature-Distributed Clustering (FDC) represented by module 322. In this method in order to produce randomized cluster results, each object to be clustered is represented as a feature vector, and only a portion of features in the entire feature space is selected to form a subspace. All the objects are then projected to the subspace to perform clustering. Given a feature space with n dimensions, theoretically there are 2ⁿ selections that can be used to build clusters. However, only m selections are sampled at random for computational convenience. FDC differs from ODC in that the clustering algorithm has access to the full set of training data but only with a subset of features. FDC can only be applied to divisive clustering, since minimum entropy clustering does not take feature vector as input.

Clustering Algorithm using Random Initialization (CARI) represented by module 324. For those clustering methods that converge to local optima, different initial settings produce different outputs. Therefore, one can randomize the clustering output using a set of random initializations. This scheme can be applied to both MEC and DC described in the previous section by randomly assigning objects to different clusters when beginning to split a cluster.

Classifier output combining module 310 can combine the outputs of individual NBCs to make the final classification decision using a number of techniques including but not limited to average classifier score, average log classifier score, and majority vote.

Average classifier score. Given l classifiers, the final classification score is the average of the member classifier's scores

$$f ( c ) = \frac{1}{l} {\sum }_{i = 1}^{l} {p}_{i} ( c ) {\prod }_{k} {p}_{i} ( {w}_{k} \vert c )$$

where pᵢ(wₖ|c) is the model parameter of the i-th classifier, estimated based on the i-th clustering results. The output of the classifier ensemble is chosen to be the class with the maximum average classifier score. In the Naïve Bayesian probabilistic setting, this method can be viewed as a special case of Bayesian voting, where each member classifier forms a hypothesis h and all hs are assumed to have an equal prior p(h)=1/l.

Average log classifier score. In this method, the classifier ensemble's score is calculated as the average of the member classifiers' log scores

$$f ( c ) = \frac{1}{l} {\sum }_{i = 1}^{l} ( log {p}_{i} ( c ) + {\sum }_{k} log {p}_{i} ( {w}_{k} \vert c ) )$$

The average log score can be viewed as the geometric mean of the member classifiers' scores while average classifier score is the arithmetic mean.

Majority vote. This is a very simple method in which a classifier generates a vote for each class under consideration, and the class receiving most votes is taken as the final output. In other words, this method uses a classification based on a majority of the classifiers ascertaining the same classification. Notwithstanding its simplicity, majority vote has the advantage that it can be used even when the scores of some of the classifiers are not available.

The foregoing technique of random feature clustering can improve the accuracy of classification for natural language statistical models. However, it should be noted that Kneser-Ney smoothing or Good-Turing smoothing can further be applied with the feature clustering method herein described.

Although the present invention has been described with reference to particular embodiments, workers skilled in the art will recognize that changes may be made in form and detail without departing from the spirit and scope of the invention.

What is claimed is:

1. A computer-implemented method of creating a natural language classifier, comprising:
building an ensemble of random feature clusters of natural language data using a clustering algorithm having some randomness; and
training a classifier for each of the random feature clusters.

2. The computer-implemented method of claim 1 wherein training a classifier comprises using a Naïve Bayesian Classifier for each of the random feature clusters.

3. The computer-implemented method of claim 1 wherein using a clustering algorithm comprises using a minimum entropy clustering algorithm.

4. The computer-implemented method of claim 1 wherein using a clustering algorithm comprises using a divisive clustering algorithm.

5. The computer-implemented method of claim 4 wherein using a clustering algorithm comprises using a minimum entropy clustering algorithm.

6. The computer-implemented method of claim 1 wherein randomness is based on extracting a subset of the training data with random replacements.

7. The computer-implemented method of claim 1 wherein randomness is based on representing each object in the training data as a feature vector and randomly selecting only a portion of features in the entire feature space to form a subspace.

8. The computer-implemented method of claim 1 wherein randomness is based on random initializations of the clustering algorithm.

9. A computer-readable medium having instructions for creating a statistical model useful in natural language processing, the instructions comprising:
a classifier ensemble module comprising a plurality of classifiers, each classifier built from random feature clusters of training data; and
combining module adapted to receive output scores from each classifiers of the classifier ensemble and to combine the output scores to make classification decisions.

10. The computer-readable medium of claim 9 wherein each of the classifiers comprise a Naïve Bayesian Classifier.

11. The computer-readable medium of claim 9 wherein the combining module is adapted to combine the output scores based on an average of the classifiers, scores.

12. The computer-readable medium of claim 11 wherein each of the classifiers comprise a Naïve Bayesian Classifier.

13. The computer-readable medium of claim 9 wherein the combining module is adapted to combine the output scores based on an average of the classifiers' log score.

14. The computer-readable medium of claim 13 wherein each of the classifiers comprise a Naïve Bayesian Classifier.

15. The computer-readable medium of claim 9 wherein the combining module is adapted to combine the output scores and use a classification based on a majority of the classifiers ascertaining the same classification.

16. The computer-readable medium of claim 15 wherein each of the classifiers comprise a Naïve Bayesian Classifier.
